(19) United States
(12) Patent Application Publication
(10) Pub. No.: US 2009/0113292 A1
(43) Pub. Date: Apr. 30, 2009

(54) FLEXIBLY EDITING HETEROGENEOUS DOCUMENTS

(75) Inventors: Florian Voss, Seattle, WA (US); Stephen M. Danton, Seattle, WA (US); Andrew C. Wassyng, Seattle, WA (US); Laurent Mollicone, Kirkland, WA (US); James R. Flynn, Seattle, WA (US); Arwen E. Pond, Woodinville, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: MICROSOFT CORPORATION, Redmond, WA (US)

(21) Appl. No.: 11/925,184

(22) Filed: Oct. 26, 2007

(51) Int. Cl. G06F 15/00

(52) U.S. Cl. 715/255

(57) ABSTRACT

The present invention extends to methods, systems, and computer program products for flexibly editing heterogeneous documents. Different types of documents can be organized on a universal and dynamically adjustable workspace canvas in a manner that indicates relationships between the documents. The workspace canvas is configured to host various different editors simultaneously for editing the different types of documents. Accordingly, embodiments of the present invention facilitate editing different typed documents within the same context and in a manner that maintains relationships between documents.

### CROSS-REFERENCE TO RELATED APPLICATIONS

N/A.

### BACKGROUND

1. Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many computing tasks are distributed across a number of different computer systems and/or a number of different computing components.

Many computing tasks include an application program manipulating data in response to user commands to express the user's intent within the data file. For example, a word processor can modify the contents of a word processing document in response to user commands received through a user-interface of the word processor. Other application programs can be used to manipulate spreadsheets, database entries, images, executable software code, etc.

In some environments, software applications (e.g., model editors) are even used to generate and manipulate models. For example, businesses and other entities may use model editors to create and modify models describing processes and systems. Such models are commonly referred to as flow diagrams, process flows, flowcharts, process diagrams and/or control charts. In other cases, model editors can be sued to create and modify models illustrating organizational relationships between resources in a system. These models are often referred to as organizational charts. However, in a broader sense, model editors can be used to create and modify models to show virtually any type of relationship between different objects.

Software applications are typically designed to manipulate documents (e.g., hierarchically organized in a file system isolated) in separate windows. A Multiple Display Interface (MDI) is often used to facilitate document manipulation. An MDI uses multiple separate windows within a common host or a tab-based model.

Most MDI approaches are problematic in a number of different ways. At least one difficultly results from context switching when moving between documents. For example, each window in an MDI typically has an independent frame (or disjoint container). Thus, at least to some extent, documents and their contents are isolated from one another. As a result, the operating system (or other management components functioning as a shell) has to manage cascading windows and keep command spaces in sync. For example, a user may desire to work with multiple different types of data. Using a repository browser the user may be required to continual switch contexts (windows) between the different types of data.

Disjoint containers can also result in a feature gap, wherein the operating system or other shell provides some document related features and the document provides other document related features. For example, using conventional searching mechanisms results are shown in an isolated task pane in the shell.

Further, interactions between documents, especially of different document types, are generally not primary operations. For example, editing of a nested or embedded document typically requires external activation of an editor compatible with the nested or embedded. Due at least in part to the use of separate editors, it can also be difficult to determine relationships between documents. Another general approach is Object linking and Embedding (“OLE”), which opens the same application, but with a disconnected experience.

Additionally, documents are typically managed within the fixed screen real estate using the operating system or they are managed directly within an application only (e.g., through whatever limited window management features the application includes). Neither mechanism persists user organization for more efficient retrieval upon subsequent use of a document. For example, most operating systems maintain open applications in a single flat list in a common location.

In many environments, applications also suffer from limited spatial optimization. For example, all documents are typically displayed in rectangular windows regardless of the shape of the content, plus the command space may also be repeated for each window (e.g., tiled SDI). Many applications also suffer from limited scaling. That is, the applications do not scale well to support increasing screen size & DPI, as well as multi-monitor support (e.g., many applications duplicate command spaces).

### BRIEF SUMMARY

The present invention extends to methods, systems, and computer program products for flexibly editing heterogeneous documents. A common workspace is configured for editing documents of a plurality of different data types. The common workspace is configured to simultaneously host a plurality of different editors. Each editor is configured for use with at least one of the plurality of different data types. A workspace canvas is presented within the common workspace. The workspace canvas visually represents a plurality documents and relationships between the plurality of documents.

A first alteration command to alter a first document within the workspace canvas is received. The first document has a first data type. A first editor add-in configured for use with documents having the first data type is identified. A first editor is hosted within the workspace canvas. The first editor is utilized to apply the intent of the first alteration command to the first document. The first editor includes the functionality of the first editor add-in.

A second alteration command to alter a second document within the workspace canvas is received. The second document has a second different data type. The second document has a visually represented relationship to the first document within the workspace canvas. A second editor add-in configured for use with documents having the second different data type is identified. A second editor is hosted simultaneously along with the first editor within the workspace canvas. The second editor is utilized to apply the intent of the second alteration command to the second document. The second editor includes the functionality of the second editor add-in

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 depicts an example computer architecture that facilitates flexibly editing heterogeneous documents.

FIG. 2 illustrates a flow chart of an example method for flexibly editing heterogeneous documents.

FIG. 3 depicts an expanded view of an example workspace for flexibly editing heterogeneous documents.

FIG. 4 depicts an example of a workspaces domain model.

FIG. 5 depicts an example of a view state domain model.

### DETAILED DESCRIPTION

The present invention extends to methods, systems, and computer program products for flexibly editing heterogeneous documents. A common workspace is configured for editing documents of a plurality of different data types. The common workspace is configured to simultaneously host a plurality of different editors. Each editor is configured for use with at least one of the plurality of different data types. A workspace canvas is presented within the common workspace. The workspace canvas visually represents a plurality documents and relationships between the plurality of documents.

A first alteration command to alter a first document within the workspace canvas is received. The first document has a first data type. A first editor add-in configured for use with documents having the first data type is identified. A first editor is hosted within the workspace canvas. The first editor is utilized to apply the intent of the first alteration command to the first document. The first editor includes the functionality of the first editor add-in.

A second alteration command to alter a second document within the workspace canvas is received. The second document has a second different data type. The second document has a visually represented relationship to the first document within the workspace canvas. A second editor add-in configured for use with documents having the second different data type is identified. A second editor is hosted simultaneously along with the first editor within the workspace canvas. The second editor is utilized to apply the intent of the second alteration command to the second document. The second editor includes the functionality of the second editor add-in.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical storage media and transmission media.

Physical storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, it should be understood, that upon reaching various computer system components, program code means in the form of computer-executable instructions or data structures can be transferred automatically from transmission media to physical storage media. For example, computer-executable instructions or data structures received over a network or data link can be buffered in RAM within a network interface card, and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, touch based devices, such as, for example, iPhone™, Microsoft® Surface, wall projections, volumetric displays and large screen wall displays, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

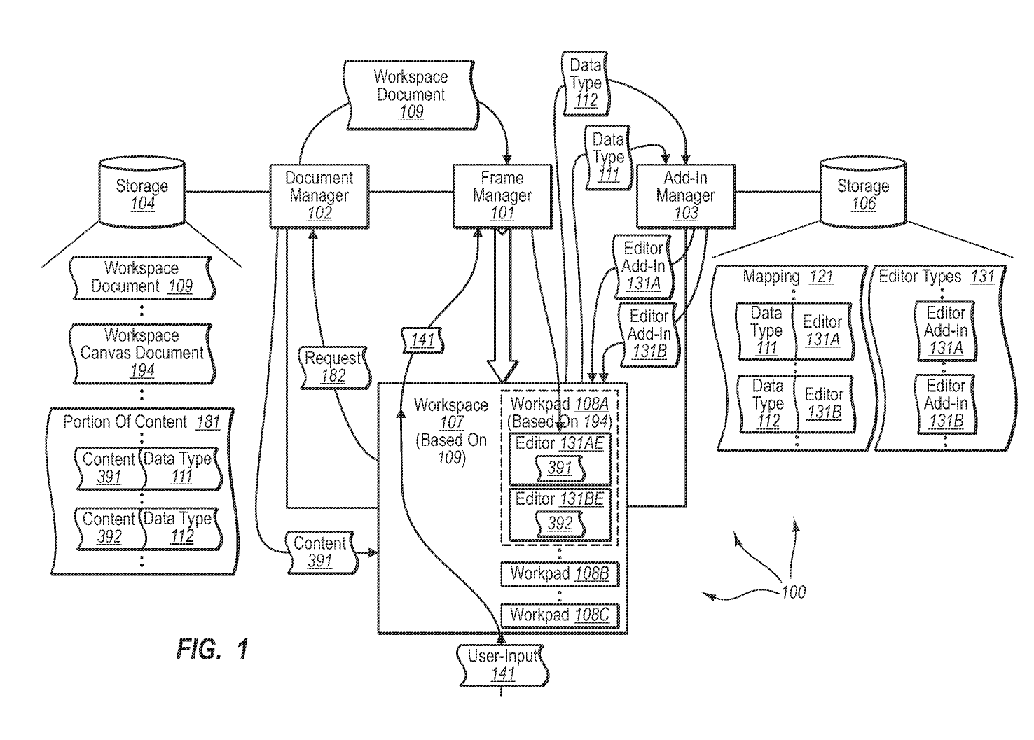

FIG. 1 illustrates an example computer architecture 100 that facilitates flexibly editing heterogeneous documents. Depicted in computer architecture 100 are frame manager 101, document manager 102, and add-in manager 103. Frame manager 101, document manager 102, and add-in manager 103 can be connected to one another over a system bus or network, such as, for example, a Local Area Network (“LAN”), a Wide Area Network (“WAN”), or even the Internet. Accordingly, components of frame manager 101, document manager 102, and add-in manager 103, as well as any other connected components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

Generally, frame manager 101 is configured to facilitate flexible editing of heterogeneous documents. Frame manger 101 can configure workspace canvases for editing documents of a plurality of different data types. Frame manager 101 can request documents that represent workspaces from document manager 102. To facilitate multi-document workspace canvases a workspace can simultaneously host a plurality of different editors. Each different editor can be configured for use with one of the plurality of different data types.

A workspace canvas can be visually presented as a user-interface at a computer system. Thus, a workspace canvas can receive user input for loading, saving, altering, accessing, deleting, etc., documents present within the workspace canvas. In response to user input, a workspace can request further documents from the document manager and match them to editors by making requests to add-in manager 103. Thus, received user-input can be forwarded to document manager 102. Based on the user-input, a workspace can then perform various operations to realize the intent indicated in the user-input (e.g., load a document, edit a document, create a relationship between documents, etc.)

A workspace can send document requests to document manager 102. A document request (e.g., request 182) can be one or more queries, filenames, URLs, etc., each representing a portion of the documents content. In response to a document request, document manager 102 can identify one or more requested portions of content form storage 104. Document manager 102 can return any identify portions of content (e.g., content 391) to the requesting workspace.

Upon receiving document content, a workspace can host an appropriate editor(s) for the document. For example, workspace 107 can determine the data type of a retuned document and submit the data type to add-in manager 103. Add-in manager 103 can refer in mapping 121 (at storage 106) to match the data type to a corresponding editor. Add-in manager 103 can then access the corresponding editor and return the corresponding editor to frame manager 101.

In some embodiments, workspace 107 includes generic editor functionality having interfaces for receiving and interoperating with editor add-ins. In these (as well as other) embodiments, a returned editor add-in can be configured to interoperate with the generic editor functionality of workspace 107. For example, a returned editor add-in can be a dynamic link library (“DLL”) configured to interoperate with generic editor functionality to implement editing operations for a specified data type. Workspace 107 can load the DLL to gain access to editing operations for specified data type. Workspace 107 can then host editors within a workspace for editing documents of the specified data type.

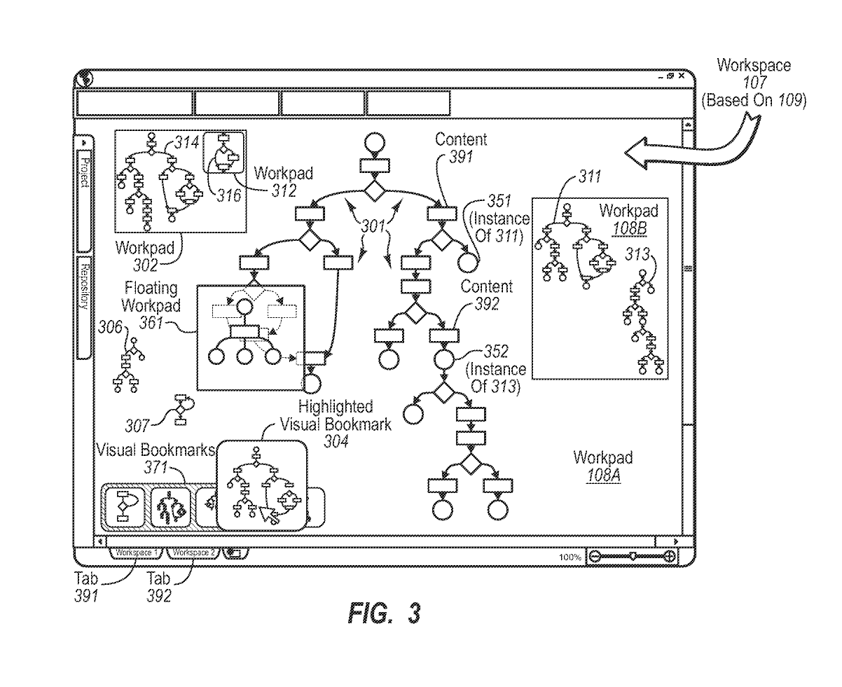

Briefly referring to FIG. 3, FIG. 3 depicts an expanded view of workspace 107 for flexibly editing heterogeneous documents.

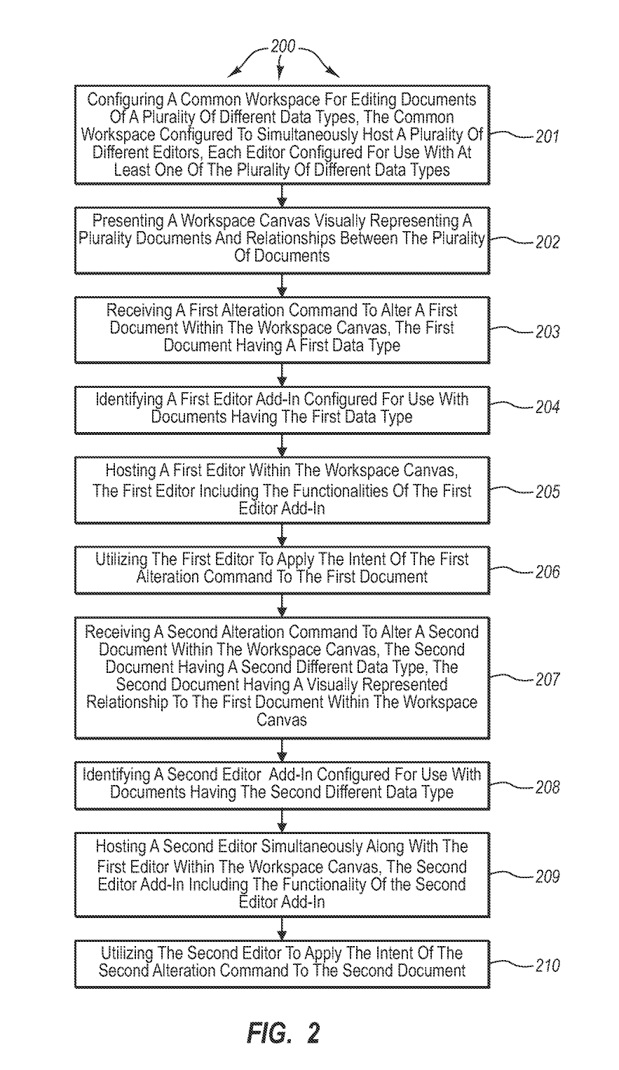

The expanded view of workspace 107 visually depicts an arrangement of various different workpads, including workpads 108A, 108B, 302, 312, and 361, containing different documents. The workpads also serve as a grouping mechanism to group together contained documents. FIG. 2 illustrates a flow chart of an example method 200 for flexibly editing heterogeneous documents. Method 200 will be described with respect to the components and data depicted in computer architecture 100 and the documents depicted in the expanded view of workspace 107. In portions of the description, components and data in computer architecture 100 and in the expanded view of workspace 107 are used interchangeably.

Method 200 includes an act configuring a common workspace for editing documents of a plurality of different data types, the common workspace configured to simultaneously host a plurality of different editors, each editor configured for use with at least one of the plurality of different data types (act 201). For example, frame manager 101 can configure workspace 107 for editing documents of a plurality of different data types. Frame manager 101 can send document request 133 to document manager 102 to request a workspace document. In response, document manager 102 can return workspace document 109 to frame manager 101. Frame manager 101 can used workspace document 109 to configure workspace 107.

Workspace 107 can be configured to host various editors (e.g., 131AE, etc.) based on editor add-in types 131. Each hosted editor can be configured for use with one of the plurality of different data types (representing in portions of content 181). For example, different hosted editors can be configured for use with different types of data (e.g., data type 111, data type 112, etc.) stored in documents 109.

Method 200 includes an act of presenting a workspace canvas visually representing a plurality documents and relationships between the plurality of documents (act 202). A workspace canvas can be a type of document that is stored in documents 109. Thus, workspace 107 can access a workspace canvas document from documents 109 and present a corresponding workspace canvas within workspace 107. For example, workspace 107 can present workpad 108A based on workspace canvas document 109. A workspace canvas can include links indicating relationships between other documents in documents 109. Workspace 107 can follow the links to access other documents within documents 109.

Thus, workspace 107 can access content for document 301 (e.g., content 391, i.e., some of the content from portions of content 181) can present document 301 in workpad 108A. As depicted, document 301 visually represents a plurality of portions of content (some of which can be other documents) and relationships between the portions of content, including content 391 and 392.

Method 200 includes an act of receiving a first alteration command to alter a first document within the workspace canvas, the first document having a first data type (act 203). For example, workspace 107 can receive user-input 141. User-input 141 can be a command to edit document 301. For example, a user can select content 391 (or some other portion of content) from document 301. Alternately, a user can enter a command to modify a portion of content.

Method 200 includes an act of identifying a first editor add-in configured for use with documents having the first data type (act 204). For example, in response to user-input 141, workspace 107 can send document request 182 (for content 391, which can be data or another document), such as, for example, a file name, a query, a URL, etc., to document manager 102. Based on document request 182, document manager 102 can retrieve document content 391 from storage 104 and content 391 to workspace 107.

Workspace can receive content 391 and access data type 111. Workspace 107 can submit data type 111 to add-in manager 103. Add-in manager 103 can refer to mapping 121. Generally, mapping 121 maps data types (e.g., data types 111 and 112) to corresponding editor add-ins (e.g., editor add-ins 131A and 131B) respectively. Accordingly, add-in manager 103 can refer to mapping 121 to determine that editor add-in 131A is the appropriate editor for content 391. Add-in manager 131 can then return editor add-in 131A (e.g., a DLL) to frame manger 101.

Method 200 includes an act of hosting a first editor within the common workspace canvas (act 205). For example, in response to receiving editor add-in 131A, workspace 107 can host editor 131AE for editing content 391. Editor 131AE can include and be based on the functionality included in editor add-in 131A. Method 200 includes an act of utilizing the first editor to apply the intent of the first alteration command to the first document (act 206). For example, workspace 107 can utilize editor 131AE to apply an editing operation to content 391.

Method 200 includes an act of receiving a second alteration command to alter a second document within the workspace canvas, the second document having a second different data type, the second document having a visually represented relationship to the first document within the workspace canvas (act 207). For example, workpad 108A can receive further user input including commands to editc content 392. For example, a user can select a link to content 392 from document 301. Alternately, a user can enter a command to modify content 392. As depicted in the expanded view of workspace 107, document 301 visually represents a relationship between content 391 and 392. That is, content 391 is linked to content 392 through a series of links between other content and/or documents.

Method 200 includes an act of identifying a second editor configured for use with documents having the second different data type (act 208). For example, in response to the further user-input, workspace 107 can send a further document request for content 392, such as, for example, a file name, a query, a URL, etc., to document manager 102. Based on the further document request, document manager 102 can content 392 form portions of content 181 from storage 104 and return content 392 to workspace 107.

Workspace 107 can receive content 392 and access data type 112. Workspace 107 can submit data type 112 to add-in manager 103. Add-in manager 103 can refer to mapping 121 to determine that editor add-in 131B is the appropriate editor for content 392. Add-in manager 131 can then return editor add-in 131B (e.g., a DLL) to workspace 107.

Method 200 includes an act of hosting the second editor simultaneously along with the first editor within the workspace canvas (act 209). For example, in response to receiving editor add-in 131B, frame manager 101 can host editor 131BE for editing content 392. Editor 131BE can include and be based on the functionality included in editor add-in 131B. As depicted in computer architecture 100, editors 131AE and 131BE can be hosted simultaneously within workspace 107 (and within workpad 108A). Method 200 includes an act of utilizing the second editor to apply the intent of the second alteration command to the second document (act 210). For example, workspace 107 and utilize editor 131BE to apply an editing operation to content 392.

In some embodiments, documents are nested within one another. For example, a first document of a first data type can be nested (embedded or references) within a second document of a second different data type. Thus, within an editor for editing the second document, the first document can be selected to trigger an editor for editing the first document. This facilitates drilling into and editing content (and other documents) in place or editing documents aside from one another (within the same workspace). This also facilitates exploration of documents in a manner that retains context between the documents.

In some embodiments, as new items are added to and/or deleted from a workspace, such as, for example, content and documents (e.g., 306 and 307), workpads (302 (which also serves as a grouping mechanism), 108B, 304), editors, etc., the size of workspace can be dynamically expanded and reduced as space requirements change. Workpads can expand infinitely to accommodate virtually any size of document and/or numbers of documents. When appropriate, scroll bars can be used to move within a workpad. A user can also manipulate other controls to pan within a workpad. Thus, a user is given the feeling of a limitless (or infinite) workspace).

Workpads facilitate opening a related document in-context of another document. Workpads can be used to present different documents relative to one another and in different locations in a workspace. In some embodiments, floating workpads are used to open a related document without directly consuming workspace area. That is, the workpad “floats” above the workspace. For example, floating workpad 361 floats above workspace 107 (over a portion of document 301). Documents in floating workpads can be disabled until the floating document is dismissed, or until the document is added to the workspace. Thus, floating workpads provide a transient and focused experience without unnecessarily disrupting the workspace layout.

Documents can also be included in multiple places within a workspace. For example, document 311 is included both in highlighted visual bookmark 304 and workpad 108B.

Workpads can be configured in a variety of formats including any number of documents. Workpads can also be nested within one another. For example, as depicted, workpad 312 (including document 316) is nested within workpad 302 (including document 314). Workpads 302 and 108B are also nested within workpad 108A.

Within a workspace, canvas space can be prioritized for documents that are currently being accessed. For example, document 301 can be increased in size in response to the selection of content 391 or 392. On the other hand, other items in workspace 107 can be reduced in size in response to the selection of content 391 or 392. Prioritization of documents permits a user to more easily focus on currently relevant documents, yet maintains other documents in context in the periphery.

Workspace 107 also includes visual bookmarks 371 arranged in a row format. Visual bookmarks 371 provide previews of bookmarks/favorites for documents. Highlighted visual bookmark 304 can be highlighted (e.g., increased in size) in response to mousing over the visual bookmark from within visual bookmarks 371.

Accordingly, embodiments of the present invention facilitate editing different typed documents within the same context and in a manner that maintains relationships between documents. Further, in some embodiments, frame manager 101 manages a plurality of tabbed workspaces through a user-interface. Referring to FIG. 3, tab 391 has been selected to cause frame manager 101 to present workspace 107. However, selection of tab 392 can cause frame manager 101 to present another different workspace. Users can add and delete tabbed workspaces as desired using the user-interface.

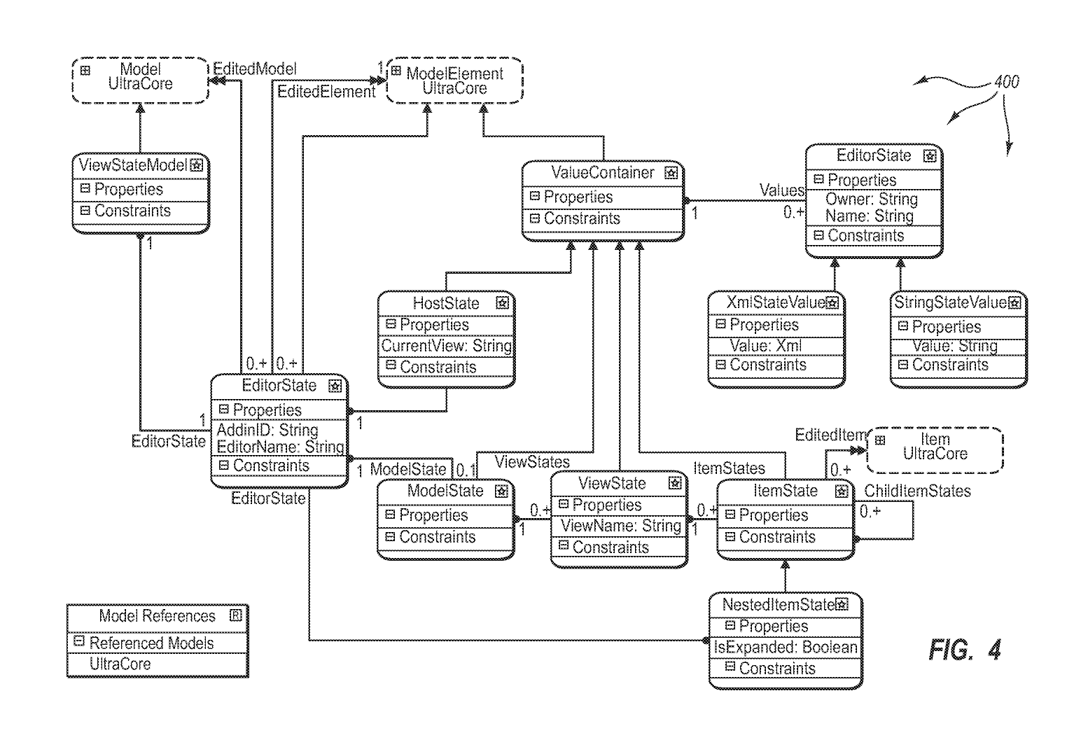

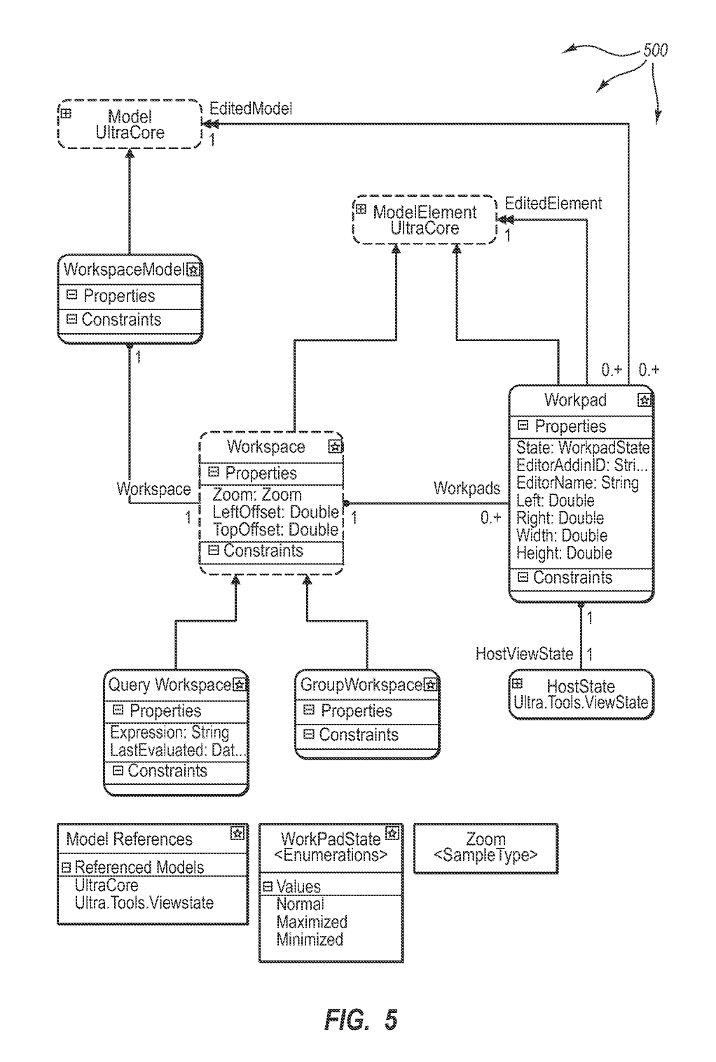

FIG. 4 depicts an example of a workspaces domain model 400. Workspaces utilized in embodiments of the present invention can be defined in accordance with workspaces domain model 500. FIG. 5 depicts an example of a view state domain model 500. View state for items depicted within a workspace can be defined in accordance with view state domain model 500.

Embodiments of the invention can also be used to close the gap between shell features and documents features. For example, a document can be a set of shell like searches or queries. This provides a seamless experience that allows a user to access what they want, wherein they want it. For example, with workspaces lists of content can be generated in response to a query. Floating workpads can be used to present a list of content. A user can then pin the workpad to a workspace (similar to any other content) for further usage. Similarly, when working with different types of content, workpads can be docked in proximity of one another to provide a more customized experience.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. At a computer system, a method for editing documents having different data types, the method comprising:
an act of configuring a common workspace canvas for editing documents of a plurality of different data types, the common workspace canvas configured to simultaneously host a plurality of different editors, each editor configured for use with at least one of the plurality of different data types;
an act of presenting a workspace canvas visually representing a plurality documents and relationships between the plurality of documents;
an act of receiving a first alteration command to alter a first document within the workspace canvas, the first document having a first data type;
an act of identifying a first editor add-in configured for use with documents having the first data type;
an act of hosting a first editor within the workspace canvas, the first editor including the functionality of the first editor add-in;
an act of utilizing the first editor to apply the intent of the first alteration command to the first document;
an act of receiving a second alteration command to alter a second document within the workspace canvas, the second document having a second different data type, the second document having a visually represented relationship to the first document within the workspace canvas;
an act of identifying a second editor add-in configured for use with documents having the second different data type;
an act of hosting a second editor simultaneously along with the first editor within the workspace canvas, the second editor including the functionality of the second editor add-in; and
an act of utilizing the second editor to apply the intent of the second alteration command to the second document.

2. The method as recited in claim 1, further comprising:
an act of presenting one or more other documents simultaneously along with the documents on the workspace canvas.

3. The method as recited in claim 2, further comprising:
an act of dynamically adjusting the area of the workspace canvas to accommodate the one or more other documents; and
an act of providing controls to scroll and pan in any direction of the workspace canvas to access documents present within the workspace canvas.

4. The method as recited in claim 2, wherein the act of presenting one or more other documents simultaneously along with the document on the workspace canvas comprises an act of presenting at least one document in a floating workpad on top of the workspace canvas.

5. The method as recited in claim 2, wherein the act of presenting one or more other documents simultaneously along with the document on the workspace canvas comprises an act of presenting at least one other workpad that also includes the first document.

6. The method as recited in claim 1, wherein the an act of receiving a first alteration command to alter a first document within the workspace canvas comprises an act of receiving user-input selecting a first document that is embedded within the second document.

7. The method as recited in claim 1, wherein the act of identifying a first editor add-in configured for use with documents having the first data type comprises an act of identifying an add-in configured to editing operations documents of the first data type.

8. The method as recited in claim 1, further comprising:
an act of visually altering the presentation of the first document in response to receiving the first alteration command to indicate that the first document has increased priority.

9. The method as recited in claim 1, further comprising prior to configuring the workspace canvas for editing documents:
an act of presenting a user-interface including a plurality of tabs, each tab corresponding to a different workspace; and
an act of receiving a user-input selecting the tab corresponding to the workspace canvas.

10. The method as recited ion claim 1, wherein the act of identifying a first editor add-in configured for use with documents having the first data type comprises:
an act of an add-in manager referring to a mapping to identify an editor add-in configured for use with the first data type; and
an act of accessing the identified editor add-in from storage.

11. The method as recited in claim 1, wherein the first document is represented by a set of queries for portions of conent.

12. A computer program product for use at a computer system, the computer program product for implementing a method for editing documents having different data types, the computer program product comprising one or more physical storage media having stored thereon computer-executable instructions that, when executed a processor, cause the computer system to perform the method, including the following;
configure a common workspace canvas for editing documents of a plurality of different data types, the common workspace canvas configured to simultaneously host a plurality of different editors, each editor configured for use with at least one of the plurality of different data types;
present a workspace canvas visually representing a plurality documents and relationships between the plurality of documents;
receive a first alteration command to alter a first document within the workspace canvas, the first document having a first data type;
identify a first editor add-in configured for use with documents having the first data type;
host a first editor within the workspace canvas, the first editor including the functionality of the first editor add-in;
utilize the first editor to apply the intent of the first alteration command to the first document;
receive a second alteration command to alter a second document within the workspace canvas, the second document having a second different data type, the second document having a visually represented relationship to the first document within the workspace canvas;
identify a second editor add-in configured for use with documents having the second different data type;
host a second editor simultaneously along with the first editor within the workspace canvas, the second editor including the functionality of the second editor add-in; and
utilize the second editor to apply the intent of the second alteration command to the second document.

13. The computer program product as recited in claim 12, further comprising:
computer-executable instructions that, when executed, cause the computer system to present one or more other documents simultaneously along with the document on the workspace canvas.

14. The computer program product as recited in claim 13, further comprising:
computer-executable instructions that, when executed, cause the computer system to dynamically adjust the area of the workspace canvas to accommodate the one or more other documents.

15. The computer program product as recited in claim 14, further comprising computer-executable instructions that, when executed, cause the computer system to:
dynamically adjust the area of the workspace canvas to accommodate the one or more other documents; and
providing controls to scroll and pan in any direction of the workspace canvas to access documents present within the workspace canvas.

16. The computer program product as recited in claim 13, wherein computer-executable instructions that, when executed, cause the computer system to present one or more other documents along with the document on the workspace canvas comprise computer-executable instructions that, when executed, cause the computer system to represent a document in a floating workpad on top of the workspace canvas.

17. The computer program product as recited in claim 11, wherein computer-executable instructions that, when executed, cause the computer system to identify a first editor add-in configured for use with documents having the first data type comprise computer-executable instructions that, when executed, cause the computer system to identifying an add-in configured to editing operations documents of the first data type.

18. The computer program product as recited in claim 11, further comprising computer-executable instructions that, when executed, cause the computer system to:
present a user-interface including a plurality of tabs, each tab corresponding to a different workspace, including a tab corresponding to the common workspace canvas; and
receive a user-input selecting the tab corresponding to the common workspace canvas.

19. The computer program product as recited in claim 11, further comprising computer-executable instructions that, when executed, cause the computer system to:
referring to a mapping to identify an editor add-in configured for use with the first data type; and
accessing the identified editor add-in from storage.

20. A computer system, including:
one or more processors;
system memory; and
one or more physical storage media having stored thereon computer-executable instructions representing a frame manager, the frame manager configured to:
configure a common workspace canvas for editing documents of a plurality of different data types, the common workspace canvas configured to simultaneously host a plurality of different editors, each editor configured for use with at least one of the plurality of different data types;
present a workspace canvas visually representing a plurality documents and relationships between the plurality of documents;
receive a first alteration command to alter a first document within the workspace canvas, the first document having a first data type;
identify a first editor add-in configured for use with documents having the first data type;
host a first editor within the workspace canvas, the first editor including the functionality of the first editor add-in;
utilize the first editor to apply the intent of the first alteration command to the first document;
receive a second alteration command to alter a second document within the workspace canvas, the second document having a second different data type, the second document having a visually represented relationship to the first document within the workspace canvas;
identify a second editor add-in configured for use with documents having the second different data type;
host a second editor simultaneously along with the first editor within the workspace canvas, the second editor including the functionality of the second editor add-in; and
utilize the second editor to apply the intent of the second alteration command to the second document.
